(19) United States
(12) Patent Application Publication
(10) Pub. No.: US 2002/0069133 A1
(43) Pub. Date: Jun. 6, 2002

(54) System and method for selling fitted putters

(76) Inventors: Kirk Currie, Spring, TX (US); Rick Wright, Spring, TX (US)

Correspondence Address: Alan R. Thiele, JENKENS & GILCHRIST, P.C., 1445 Ross Avenue, Suite 3200, Dallas, TX, 75202-2799, US

(21) Appl. No.: 10/005,019

(22) Filed: Dec. 4, 2001

Related U.S. Application Data
(60) Provisional application No. 60/251,069, filed on Dec. 4, 2000.

(51) Int. Cl. G06F 17/60; A63B 53/00; A63B 55/00

(52) U.S. Cl. 705/26; 473/282

(57) ABSTRACT

The invention relates to a system for selling putters at the critical point of purchase. The purchaser of a putter first selects an un-customized putter having the club head, offset, and shaft length characteristics desired. Then the purchaser is instructed on how to bend the hosel at the point of purchase to create a putter with a desired lie angle and desired loft angle.

### This application claims the benefit of U.S. provisional patent application Ser. No. 60/251,069, filed Dec. 4, 2000.

### FIELD

The present invention relates to a method of doing business; more particularly, the present invention relates to a system and method for selling golf clubs, particularly custom fitted putters, to individual golfers.

### BACKGROUND

It is well recognized that the proper fitting of a golf club to the physique and playing style of an individual golfer will enhance a golfer's performance.

Golfing equipment, custom fitted to the physique of an individual golfer, has been traditionally sold through golf courses or driving ranges by trained professionals. Golf club specifications are determined by the professional fitter and provided to the manufacturer. The manufacturer then produces the clubs to specification and ships them to the customer. This process may take several days or weeks.

Although this method of custom fitting is offered by certain manufacturers as it applies to the putter, the vast majority of putters are sold “off the rack” with industry standard specifications through pro shops, golf specialty stores, sporting goods stores, and discount retail stores. Although putting appears to be a relatively simple process, it is actually requires a precise alignment of putter surface angles. The key characteristics of a putter affecting these critical surface angles are shaft length, lie angle, and loft angle.

Although equipment bending machines exist which can alter the critical lie angle and loft angle of a putter, the following problems exist in the marketplace:

Bending equipment is relatively expensive; and therefore, are not readily available at most retail stores or pro shops.

Most putters are not designed with the intent of bending lie angle or loft angle. Therefore, the risk of breakage is high.

Most importantly, a method/device/system of bending putter lie angle and loft angle is not available to the consumer at the critical point of purchase.

Accordingly, there is presently a need for a method/device/system that can be used in all stores at the point of purchase where golf clubs, particularly putters, are sold to enable a golfer to properly select and fit a putter suitable to the golfer's individual physique and playing style so that the golfer will enhance their performance.

### SUMMARY

The system of the present invention enables a golfer to properly select and customize a putter for the golfer's own physique and playing style at the point of purchase. The disclosed method of selling a putter to a golfer includes a device which presents a golfer with a variety of putters having different club head styles. Included in the variety of putters with different club head styles are those putters having an offset, no offset, or negative offset. Also included in the collection of putters are putters having a variety of shaft lengths.

Once a club head has been selected, the golfer is first instructed on what type of offset he/she should be looking for in a putter. Following the selection of a putter with the desired club head style, the necessary offset, and a comfortable shaft length from a group of un-customized putters, the golfer is instructed to grip the shaft of the selected un-customized putter and assume a comfortable stance to determine whether or not the bottom of the putter head is lying substantially parallel to a horizontal plane. If the bottom of the putter head is not laying flat with respect to a substantially horizontal plane, the golfer is instructed to place the putter head in a vise with a shaped chuck behind the putter head. Each putter is manufactured with a hosel specifically designed for bending lie angle and loft angle. The shaped chuck assures that the vise jaws will hold the putter head in place. The golfer is then instructed to use a bending bar on the bottom of the shaft to bend the hosel so that the lie angle of the putter head with respect to the shaft causes the putter head to lie substantially flat with respect to a horizontal plane. The golfer is then instructed of the necessity to assure that the loft angle of the face of the club head produces the optimum roll when the ball is struck (the optimum roll is produced with approximately 3° of loft). To achieve the optimum roll, the putter head is once again placed in the vise. The bending bar is used again to bend the hosel so that the loft angle of the face of the putter head can be increased or decreased in order to achieve the loft angle from vertical at that point in the stroke where the golfer strikes the ball with the putter producing the optimum roll of the golf ball.

The golfer is then instructed to modify the feel of the putter by attaching a selected shaped weight to the bottom of the putter head with the threaded fasteners. Following the completion of the disclosed method using the system of the present invention, a golfer will be able to purchase a putter which not only includes those features which the golfer looks for in a putter, but the golfer will be able to assure that the selected putter is customized for individual physique and playing style at the point of purchase.

### BRIEF DESCRIPTION OF THE DRAWING FIGURES

A better understanding of the system and method of the present invention may be had by reference to drawing figures, wherein:

FIG. 1 is a schematic view of a putter illustrating its pendulum motion;

FIG. 2 is a schematic view of the true position and the perceived visual position of the cup to a golfer;

FIG. 3A is a front elevational view of a putter having a head that is sitting toe high;

FIG. 3B is a front elevational view of a putter having a head that is sitting heel high;

FIG. 3C is a front elevational view of the adjustment of the lie angle;

FIG. 4A is a side elevational view of a putter showing the offset;

FIG. 4B is a side elevational view of a putter showing the loft angle;

FIG. 4C is a side elevational view of the adjustment of the loft angle;

FIG. 5 is a front elevational view of a display embodying the system and method of the present invention; and

FIG. 6 is an exploded perspective view of the bottom of a weighted putter.

### DESCRIPTION OF THE EMBODIMENTS

A better understanding of the method and system of the present invention may be had by a brief introduction into the science of putting and a brief introduction into the geometry of a putter.

### Introduction to the Science of Putting

Putting is unlike the other strokes in the game of golf. Generally, shots made by clubs known as drivers and irons are made for distance. A driver or an iron is used to cause the golf ball to become airborne. A putter is not designed to launch a golf ball into the air. Rather, a putter is used to cause a golf ball to roll over a putting green along a path predetermined by a golfer with just enough velocity to cause the golf ball to arrive at the cup and fall in. The mechanics of first ascertaining a path for the golf ball to travel over a putting green and then swinging a putter in a tightly controlled arc to strike a golf ball with the face of the club head with sufficient force to cause the golf ball to travel the required direction and distance to fall into the cup involves understanding a complex combination of both the force and direction vectors which affect the roll of a golf ball over the putting green. Specifically, the golfer must transfer just enough of the momentum of the moving putter head to the golf ball to overcome the rolling friction along a predetermined path from where the golf ball is resting to the cup.

In its simplest form, the motion of a putter head is like the swinging of a pendulum. It is well known by most students of elementary mechanics that the weight at the bottom of the pendulum will affect the swing of the pendulum. Accordingly, the weight of the club head affects the momentum of the club head as it moves through an arc to strike the golf ball and thereby cause the golf ball to roll along the green towards the cup. The greater the momentum of the head of the putter—the greater the tendency of the head of the putter to not deviate from the path desired by the golfer.

Most golfers, when practicing their putting game, practice their putting stroke as if the putter were a simple pendulum. Accordingly, for a golfer skilled at putting, the only variables that need to be worried about are the force with which the putter head hits the golf ball and the orientation of the face of the putter head. But, unfortunately, a putter which is mis-fitted to a golfer's physique or playing style introduces additional obstacles for a golfer attempting to successfully complete a putt.

The keys to an effective putting stroke are proper alignment and sound putting fundamentals. Sound fundamentals include both a consistent and comfortable posture and muscle control. The putting posture of the golfer is extremely important because it affects the individual's ability to execute a proper and consistent stroke. Each individual has a natural stroke plane. The objective of putting is to keep the putter on this natural plane, striking the golf ball with the correct momentum. Because a golfer is required to stand the side of the ball and target line, their stroke plane creates a slight, but unique arc with the target line. The unique angle of an individual's stroke plane is determined by their posture and hand position. The variance of stroke planes can be ten degrees or more from one individual to the next. In order to enhance the individual's ability to consistently execute their natural stroke plane, it is important to match the lie of the putter with the angle of the stroke plane. The system and method of the present invention enables a golfer to obtain a putter with the matching lie angle to an individual's stroke plane at the point of purchase.

As previously indicated, the key to allowing a golfer to achieve a proper stroke to with the best muscle control when putting a golf ball is the proper fitting of the putter to the golfer. An improper fit of a putter to a golfer can result in an inadvertent change of the angle at which the face of the putter strikes a golf ball by just a few tenths of a degree. Even a change of a few tenths of a degree will affect the ability of a golfer to accurately strike a golf ball with the face of a putter to cause the golf ball to roll along a desired travel path on the putting green toward the cup.

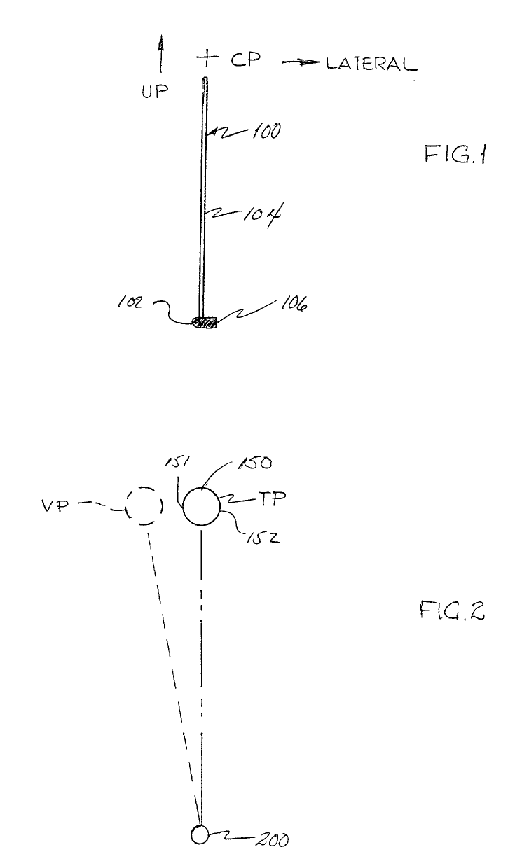

If all golfers were like simple pendulum mechanisms, all that would be required would be a proper aim and the proper amount of striking force to assure that the golf ball is accelerated to a sufficient velocity to overcome the friction of rolling across the putting green to reach the cup. Unfortunately, golfers are not like a true pendulum support system. As the golfer strokes the putter head through their natural stroke plane to strike the golf ball and cause it to roll across the green towards the cup, several things can happen which will distort the arc through which the putter head travels. As shown in FIG. 1, the golfer may inadvertently stand a bit more erect during the actual swinging of the putter 100, standing a bit more erect during the putting stroke will move the center point CP of the swing upwardly as shown in FIG. 1. Second, while the golfer may intend to stroke the putter head 102 in an arc substantially in alignment with the desired path of travel of the golf ball, the actual swing of the golfer may cause the face of the putter head 102 to be at a slight angle with regard to the desired path of travel of the golf ball. Third, the golfer may actually twist the golf club around the long axis of the shaft 104 while the club head 102 is being swung towards the golf ball, thus changing the angle at which the face 106 of the club head 102 strikes the golf ball. And fourth, the golfer may actually move the center point CP of the swing laterally as shown in FIG. 1 while the club head 102 is being moved toward the golf ball. Such lateral movement of the center point CP of the swing may change the loft angle at which the face 106 of the club head 102 hits the golf ball. Insufficient loft angle increases the force necessary to overcome the rolling friction between the golf ball and the putting green. A loft angle that is too great may actually lift the golf ball from the surface of the putting green and thereby compromise directional control of the path traveled by the golf ball over the putting green.

Still further complicating the process of putting a golf ball towards a cup is the fact that most many golfers do not necessarily see the cup 150 in its true position TP on the earth's surface as shown in FIG. 2. Accordingly, many golfers aim at what they see, or the visual perception VP of the cup, and not at the true position TP of the cup. There must be a compensation in their stroke to accurately putt a golf ball 200 into the cup 150, their aim is not towards the center of the cup 150, but rather their aim is toward either the left edge of the cup 151 or the right edge of the cup 152. It is possible, by correct fitting of a putter to a golfer, to correct for most golfers' natural tendency to be either left-eyed or right-eyed. This correct fitting of the putter to compensate for a golfer's left-eyedness or right-eyedness will allow the golfer to aim at the target most easy to see—the center of the cup.

While many golfers learn the game of golf using a standard blade putter, those golf professionals who seek to improve a golfer's ability to make accurate putts realize that the proper fitting of a putter to a golfer is a complex process where even slight adjustments to the geometry or balance of the putter can have a dramatic impact on the golfer's ability to cause the golf ball to begin a roll from a resting position over a putting green towards the cup. Over the years, such changes to putters have included adding more weight to the putter head to increase the momentum of the putter head to overcome the body movements of the golfer during the putt. Still other improvements to putters have involved distributing the weight of the club head. Some putters with large heads have a perimeter that looks like a semi-circle. Still other putters feature heads which concentrate the weight at the heel and toe of the putter head. It has been found that the proper selection of club head style is very personal to most golfers, but proper selection of club head style is just the first step in properly fitting a putter to the physique and playing style of an individual golfer.

### Introduction to Putter Geometry

Once a golfer has selected a club head style with which he or she feels most comfortable, the most important characteristics to fit a putter to the physique and playing style of an individual golfer are shaft length, lie angle, offset, loft angle, and total club weight. By customizing each of these characteristics to an individual golfer, a putter can be adjusted to suit an individual golfer's comfort and natural stroke plane. Otherwise, an individual golfer must adjust his or her body position to suit the putter, compromising comfort and stroke plane. Specifically, the more comfortable a golfer is while putting, the lesser the tendency to move the center point CP of the swing (see FIG. 1) or twist the putter shaft when actually striking a resting golf ball with the face of the putter head. Shaft Length

When fitting a putter to the physique of an individual golfer, the objective is to find the ideal shaft length that fits a person's arm and hand position when standing comfortably near the golf ball. Because the grip portion of a golf club is approximately twelve inches long, one shaft length can accommodate a large number of golfers of different heights. Short golfers or tall golfers generally require shorter or longer shaft lengths, respectively. A correct shaft length will allow the golfer to assume a comfortable posture, proper lie angle, and best achieve the natural stroke plane when moving the putter to cause the golf ball to follow the path desired across the putting green. Some putters use a hunched-over or stooped posture; however, such postures often interfere with the golfer's ability to move the head of the putter in a true pendulum motion. Still others stand too straight and are unable to attain proper control of the club head face as it strikes the golf ball. A proper putter shaft length will allow the golfer to have a comfortable grip, a comfortable stance, and the ability to achieve the natural stroke plane when causing a golf ball to roll from a stationary position across a putting green into the cup.

### Lie Angle

In general, accurate putting is all about assuring that all of the angles which affect the position of the face of the putter as it hits the golf ball are proper. The most basic of these angles is the lie angle, the angle between the putter head and the club shaft. There is a direct correlation between the shaft length of the putter and lie angle. One clearly affects the other. Typically, both shaft length and lie angle influence the posture of the golfer, how the golfer's arms hang when holding the putter, how the putter head sits with respect to the surface of the putting green, and most importantly the stroke plane of the putter. The optimum lie angle of a putter head should compliment the natural stroke plane of an individual such that the putter head sits level or substantially parallel to a horizontal plane. When a putter head sits level on the ground, the margin of error or the size of the “sweet spot” is increased by optimizing the hitting area where the center of mass of the putter head will be in alignment with the travel path of the golf ball so that a force vector describing the momentum of the moving putter head will be in alignment with the desired travel path of the golf ball across the putting green toward the cup.

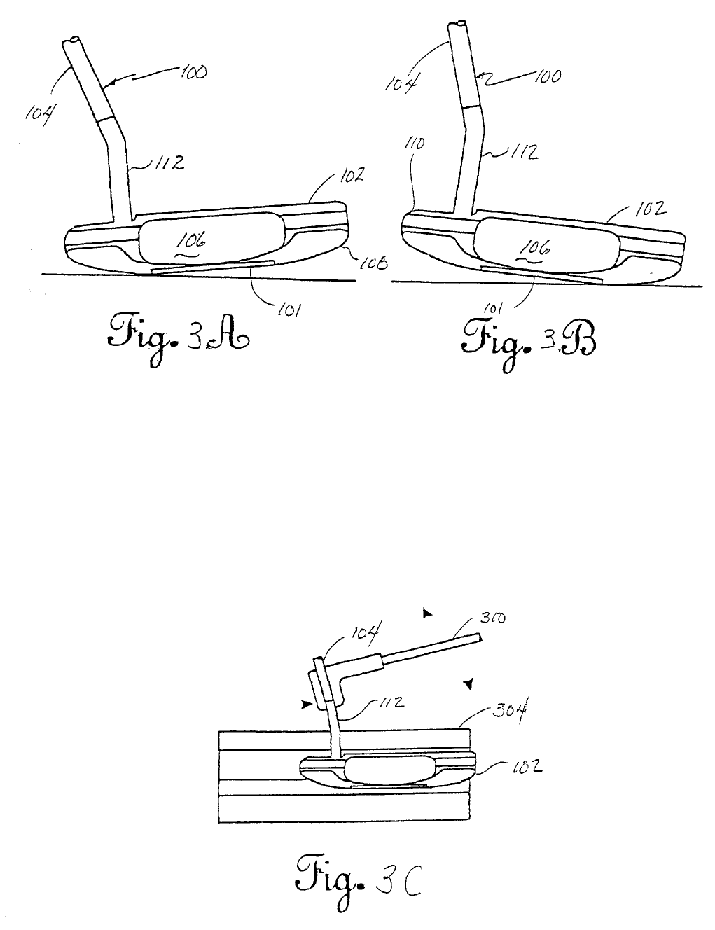

Lie angle should be adjusted so that the bottom 101 of the putter head 102 is sitting substantially flat with respect to a horizontal surface. FIG. 3A illustrates a putter head 102 that is sitting toe 108 high, and FIG. 3B illustrates a putter head 102 that is sitting heel 110 high. It is well known that a putter head 102 when caused to sit substantially parallel to a horizontal plane, will increase the golfer's chances of hitting the golf ball in alignment with the center of mass of the putter head 102. The area on the face of the putter head in alignment with the center of mass of the putter head is commonly called the “sweet spot.” If the golf ball is hit at a point away from the “sweet spot,” the force of the impact of the moving club face 106 with the stationary golf ball may cause the putter shaft 104 to actually twist around its long axis. This twisting of the putter head 102, even a fraction of a degree, will change the orientation of the face 106 of the putter head 102. This change in orientation of the face 106 of the putter head 102 can misdirect the path of the golf ball away from the travel path to the cup across the putting green selected by the golfer.

### Offset

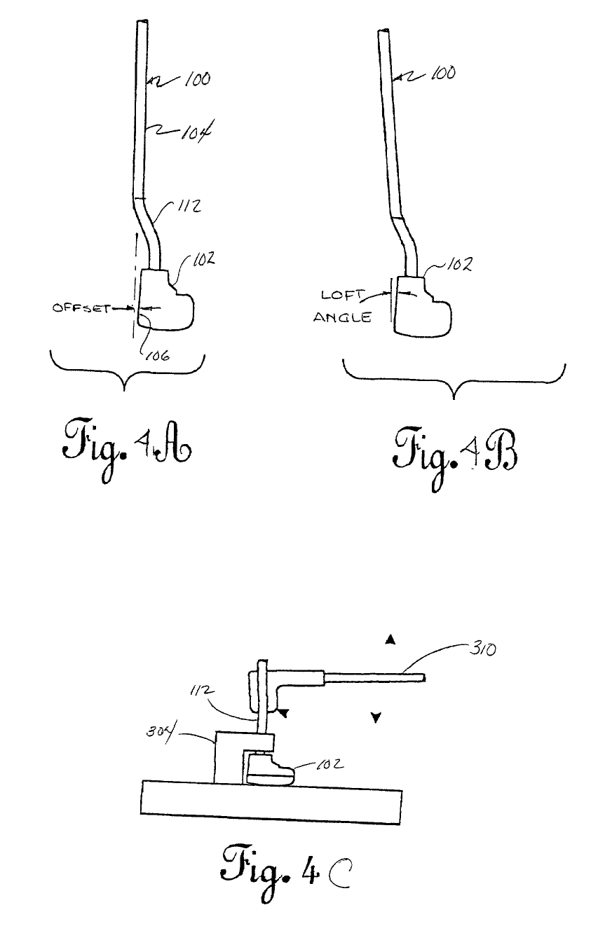

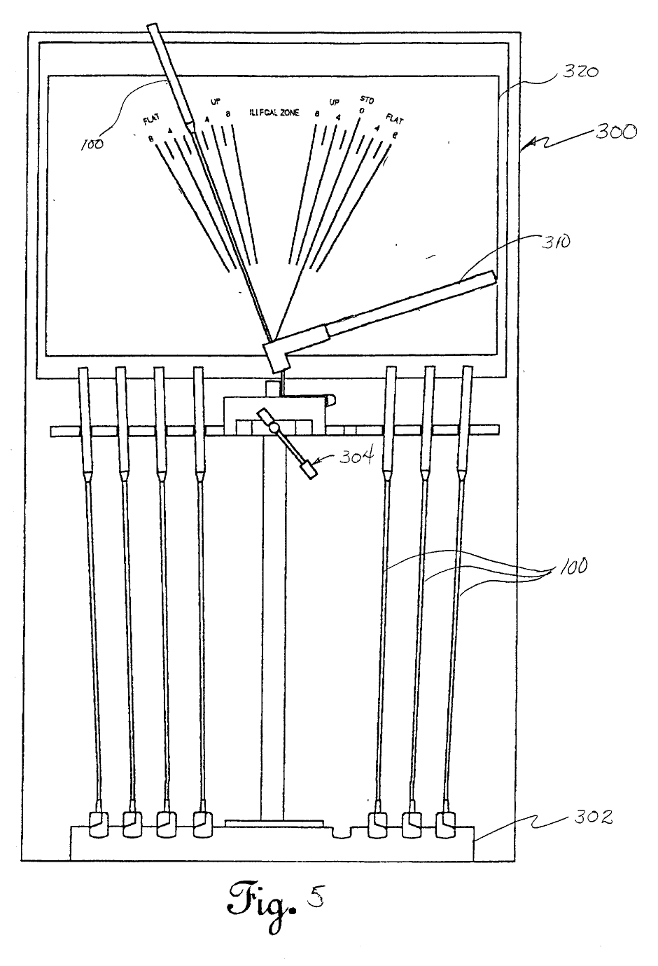

As may be seen in FIG. 4A, offset is the distance that an extension of the long axis of the club shaft 104 either in front of or behind the plane of the putter face 106. It has been found that offset has a dramatic influence on an individual's aim. Specifically, increased offset will tend to improve the accuracy of a right-handed putter with left aiming tendencies. The opposite is true for left-handed golfers.

More than nine out of ten golfers actually misalign the position of the face 106 of the putter head. Misalignment of the face of the putter head causes the golf ball to roll along a path over the putting green which will not cause the golf ball to fall into the cup. This misalignment of the face 106 of the putter head 102 is not done voluntarily by a golfer; rather, this misalignment is due to natural characteristics of the golfer's physique and vision. Unfortunately, any natural tendency to actually misalign the face 16 of the putter head 102 produces unnatural compensations in an individual's putting stroke. It has been found that hosel 112 offset or the absence thereof can actually improve the ability of a golfer to visually align the face 106 of the putter head 102 with the desired travel path so that the golf ball will roll along the path which causes it to fall into the cup. In general, a right-handed golfer with left-aiming tendencies will be able to improve the alignment of the putter face 106 with the cup with increased offset. Conversely, a right-handed golfer with right-aiming tendencies will be able to improve alignment of the putter face with the cup with decreased offset. The opposite is true for left-handed golfers.

### Loft Angle

As shown in FIG. 3B, the loft angle of a putter face 106 is the angle of the face 106 of the putter head 102 away from vertical when it strikes a stationary golf ball. Ideally, the loft angle will cause the motion of the putter head 102 to slightly lift the golf ball to roll just on top of the grass on the putting green. Small tweaks of the loft angle will change the entire look of a putter and the rolling characteristics of the golf ball. Optimum loft angle is approximately 3° as the putter face strikes the golf ball. It has been found that the loft angle is most relevant when considering the position of the golfer's hands on the putter and the position of the golfer's feet with respect to the golf ball. Specifically, if a golfer stands so that the golf ball is nearer the back or trailing foot, the loft angle is less than 3° and more force is required on the putting stroke because the golf ball is not initially lifted to roll along the top of the grass on the putting green. Similarly, if the golfer stands so that the golf ball is nearer the front or lead foot, the loft angle is greater than 3° and the golf ball, when struck by the face of the putter, will actually hop off the face of the putting green before beginning its roll toward the cup.

Many golfers believe that different styles of putters cause a golf ball to roll differently across a putting green. The only aspect of putter geometry which significantly contributes to the roll of a golf ball across a putting green is the angle of the face 106 of the putter head 102 when it strikes the golf ball. The differences that most golfers perceive in the way a golf ball rolls across a green can be attributed to how much the face 106 of the club head 102 lifts the golf ball and causes it to roll either on top of or through the grass on the putting green. The lift imparted to a golf ball by a putter is directly dependent on the loft angle of the face 106 of the putter head 102. Unfortunately, the optimum loft angle of the face 106 of the putter is different for every golfer. And even a small change in the loft angle, just tenths of a degree, will have a dramatic effect on the way the golf ball rolls along the putting green.

### Club Head Weight

The momentum of the putter head as it strikes a stationary golf ball is directly proportional to the weight of the club; particularly, the weight of the club head. Since momentum tends to prevent a moving body from deviating away from a chosen path, the greater the momentum of the putter head, the smaller the opportunity for the angle of the face of the putter head to change before the putter actually strikes the golf ball. For each inch that a putter shaft is shortened, it has been found that about 15 grams of additional weight must be added to the putter head to retain the same amount of momentum of the club head to assure a consistent swing.

A suitable club weight is also determined by the strength of an individual golfer and what weight feels best to that individual golfer in a comfortable putting stance. Specifically, it has been found that the performance of most golfers on the putting green can be improved by increasing the momentum of the moving club head as it strikes the stationary golf ball. This is because most golfers use putters that have insufficient head weight. The ultimate goal for a successful putt is to align the momentum of a moving putter head to impart enough energy to a stationary golf ball such that the golf ball has sufficient momentum in a desired direction to overcome the friction of rolling over a putting green to reach the cup and fall in without rolling past the cup. The putting process can be improved when the golfer has maximum feel through the shaft of the putter as the face of the putter head strikes the stationary golf ball. Since most people prefer a shaft length shorter than the industry standard of 35 inches, the loss of control of the putting stroke through loss of momentum can only increase. To maintain a consistent swing weight, for every inch that the shaft length is shortened, approximately 15 grams must be added to the putter head to properly balance the putter head in the hands of the golfer.

### SYSTEM OPERATION

Having now established the various aspects of the science of putting and those aspects of a putter which need to be tailored to the individual physique and playing style of a golfer, the problem remains of how to enable a golfer to select and customize a putter which will improve his/her ability to successfully roll a golf ball across a putting green and into the cup.

The device or system of the present invention enables the selection and customization of a putter by the individual golfer and is fabricated to be placed in any type of establishment which sells putters.

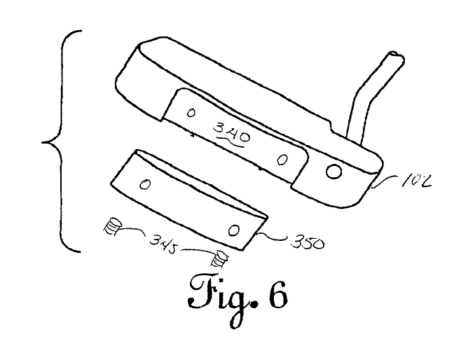

When a customer approaches the in-store display 300 as shown in FIG. 5, the customer will find a collection of un-customized putters 100 having various different head styles. For example, a blade style putter, a mallet style putter, a heel-toe weighted putter, and other styles of putters may be included in the collection. In addition to putters 100 having different styles of heads, putters having heads made from various different types of materials may also be added to the selection of un-customized putters available to the golfer. For example, putters in the collection may include a putter head milled from a solid block of carbon steel or a putter with a head which has been made from brass or Telluriun copper. Also included in the collection will be putters with an offset, no offset, or a negative offset.

The prospective purchaser of a putter is instructed to select a particular putter whose general balance and visual impression is suitable and comfortable when gripped. Sometimes the golfer may prefer a putter head with a large visual surface such as a mallet head. Still other golfers may have become accustomed to a blade type putter or feel most comfortable with a heel-toe weighted putter head. Some golfers feel that they are helped with their putting accuracy by the inclusion of one or more sight lines on the top of the putter head.

Either before the golfer selects a putter or after the golfer selects a putter, the salesperson will determine the alignment tendencies of prospective purchaser. This can be achieved by observing several putts along a flat surface to a target approximately 10-12 feet away. If the alignment tends to be left of target for a right-handed golfer, the prospective purchaser of a putter will be encouraged to select a putter which includes some more offset. If the alignment tends to be right of target a right-handed golfer will be encouraged to select a putter which includes a less offset. Offset selection is just the opposite for left-handed golfers.

In addition to the display of putters including various different style putter heads and putters having various different offsets, the putters 100 with the display 300 will also have various different shaft lengths. The prospective purchaser will then be instructed to select a putter from the uncustomized clubs which already includes the type of club head desired, the offset required (if any), and the most comfortable shaft length.

At this point in the purchase process, the golfer is then instructed to assume a normal comfortable putting stance with the selected putter. Either by the use of a mirror attached to the base 302 of a display 300 or with the assistance of a salesperson, the prospective purchaser will be able to determine if the bottom surface 101 of the club head 102 is in a plane substantially parallel to horizontal. If the bottom surface 101 of the club head 102 is slanted towards the heel 110 of the club head 102 as shown in FIG. 3A, or towards the toe 108 of the club head 102 as shown in FIG. 3B, the prospective purchaser is then instructed to place the head 102 of the golf club in a vise assembly 304 which is also located on the display assembly 300. To securely hold the club head 102 in place in the vise assembly 304, an array of chucks (not shown) is made available so that the vise assembly 304 is able to both position and securely hold the club head 102 in a position for proper bending. The chucks are shaped to engage the back of the putter head 102. With the club head 102 properly chucked within the jaws of the vise 304, a bending bar tool 310 is then placed at the lowest possible point on the club shaft 104 as shown in FIG. 3C. This is the place at which the hosel 112 both enters the club head 102 and enters the hollow portion of the club shaft 104. The bending bar tool 310 is then used to bend the hosel 112 so that the lie angle of the putter results in the bottom surface 101 of the club head 102 being substantially parallel to a horizontal plane. Because there are rules which govern the lie angle of putters, the display assembly 300 includes a board 320 as shown in FIG. 5 so that the purchaser can assure that the lie angle of the customized putter is within the limits of the rules governing club geometry. The scale on the left of the board 320 for right-handed golfers, and the scale on the right of the board 320 for left-handed golfers facilitates future lie angle adjustments.

Because it is important that the face 106 of the club head 102 have a loft angle of approximately 3° as shown in FIG. 4B, the golfer is once again asked to hold the putter 100 in a position where the golf ball is hit. By observing the position of the face 106 of the putter head 102 as it comes into a position to hit the golf ball, it can be determined whether or not the club face 106 is actually striking the golf ball at an angle of approximately 3°. If the face 106 of the putter head 102 is approximately vertical when it strikes the golf ball, which typically occurs when the ball position is closer to the leading or front foot, then the angle of the face 106 should be increased. If, however, when the golfer hits the golf ball, the club face 106 causes the ball to actually lift up and possibly skip across the green, then the loft angle will have to be decreased.

When adjusting the loft angle, the following should be kept in mind:

1. When the golfer's stance positions the ball closer to the front foot, the putter usually requires a decreased loft angle. When the golfer's stance places the golf ball in the middle of the stance, increased loft is generally required.

2. When the golfer's hands are in front of the golf ball (forward pressed), a greater loft angle is needed. If the golfer's hands are behind the golf ball, a decreased loft angle is generally required.

3. Minor changes in the loft angle result in significant differences in the way that the golf ball begins its roll across the green and the way that the club head looks to the golfer when the putt is being made. When the golf ball seems to hop off the face of the putter head, the loft angle should be decreased. When the golf ball seems to skid across the green, the loft angle should be increased.

The loft angle is adjusted using the bending bar tool 310 placed at a right angle to the use of the tool 310 shown in FIG. 3C. Once again the club is placed in the vise 304 and the bending bar tool is placed at the bottom of the club shaft 104 near the hosel 112. Moving the bending bar tool 310 up will bend the hosel 112 to increase the loft angle, and moving the bending bar tool 310 down will decrease the loft angle.

As shown in FIG. 6, after both the lie angle and the loft angle have been set, the golfer is then instructed to try different weights 350 on the bottom of the putter head. These different weights 350, typically in the range of 330 to 375 grams, will impart different feel to the putter and assist the golfer in achieving a smoother pendulum style swing. As shown in FIG. 6, the selected weight is sized to fit within a recess 340 formed on the bottom of the putter head 102 and are attached to the putter head 102 using threaded fasteners 345.

If the golfer then uses the customized putter made at the fitting center 300 described above and finds that certain adjustments still need to be made, the putter may be returned to the fitting center 300 and small adjustments may be repeatedly made to either the lie angle, the loft angle, or the weight of the putter until the golfer has a putter optimally customized to fit his/her physique and compliment his/her playing style.

It is important to note that with the exception of the initial lie angle bend, all customizing adjustments to the putter should be extremely minor. Such minor adjustments have been found to produce dramatic results in the ability of a golfer to accurately roll a golf ball across a putting green and have it fall in the cup.

It will be understood by those of ordinary skill in the art that the putter fitting system and method described above may include other embodiments well known to those of ordinary skill in the art. Such other embodiments shall be included within the scope and meaning of the appended claims.

What is claimed is:

1. A method of selling a putter complete at point of purchase to a golfer comprising the steps of:
(a) providing the golfer with instruction on how to select a putter from a group of putters having a variety of different hosel offsets;
(b) providing the golfer with a visual indication of whether the bottom of said selected putter is substantially parallel to a horizontal plane;
(c) providing the golfer with a bending bar and instructing the golfer on how to use a vise for holding the club head and the bending bar for:
(i) adjusting the lie angle so that the bottom of said selected putter is substantially parallel to a horizontal plane;
(ii) adjusting the loft angle so that the loft angle is approximately 3° from a vertical plane;
(d) providing the golfer with a selection of weights, said selection of weights including individual weights constructed and arranged to be mountable to the bottom of the putter head;
(e) instructing the golfer on how to mount a selected one of said individual weights to the bottom of the putter head;
whereby, a golfer is able to customize a putter to his/her physique and playing style at the point of purchase

2. The method as defined in claim 1 further including the steps of repeating step (c)(i) and (c)(ii) until the feel of the putter is satisfactory to the golfer.

3. The method as defined in claim 1 wherein the group of putters having a variety of different hosel offset angles further includes putters having different head styles and different shaft lengths.

4. The method as defined in claim 1 wherein step (a) is preceded by the steps of determining the left/right aiming tendency of the golfer and providing the golfer with advice on the type of offset needed to correct the left/right aiming tendency.

5. An in-store display device for assisting a golfer with the purchase of a customized putter, said device comprising:
means for displaying a group of un-customized putters having a variety of different offset angles to the golfer so that the golfer may select one of said un-customized putters;
means for providing the golfer with a visual indication of whether the bottom of said selected putter is substantially parallel to a horizontal plane;
a vise constructed and arranged for holding the head of said selected putter;
a bending bar to be used with said vise for:
(i) adjusting the lie angle to match an individual's natural stroke plane and ensure that the bottom of said selected putter is substantially parallel to a horizontal plane;
(ii) adjusting the loft angle so that the loft angle of said selected putter is optimum for each unique individual at approximately 3° at putter head impact with
golf ball from a vertical plane;
a scale for assisting the golfer in setting the lie angle;
means for adjusting the weight of the putter head;
whereby, a golfer is able to customize a putter to his/her physique and playing style in-store.

6. The device as defined in claim 5 wherein said group of putters further includes putters having a variety of different head styles and a variety of different shaft lengths.

7. A system for assisting a store salesperson in selling a putter to a golfer, said system comprising:
a selection of preformed putters, said selection of preformed putters having a variety of different offset angles;
instructions on how to select an offset angle;
a visual system for determining if the bottom of the putter is substantially parallel to a horizontal plane when the golfer holds the putter in a manner used to make a putt;
means for adjusting the lie angle of the putter shaft with respect to the club head;
means for adjusting the loft angle of the putter head with respect to the shaft;
whereby, the salesperson is able to assist a golfer in customizing a putter to his/her physique and playing style.
